(19) United States
(12) Patent Application Publication
(10) Pub. No.: US 2023/0412923 A1
(43) Pub. Date: Dec. 21, 2023

(54) SIGNAL PROCESSING DEVICE, IMAGING DEVICE, AND SIGNAL PROCESSING METHOD

(71) Applicant: SONY SEMICONDUCTOR SOLUTIONS CORPORATION, KANAGAWA (JP)

(72) Inventors: NAOYA HANEDA, KANAGAWA (JP); SEIJI KADOTA, KANAGAWA (JP); MIKITA YASUDA, KANAGAWA (JP)

(21) Appl. No.: 18/250,253

(22) PCT Filed: Oct. 20, 2021
(86) PCT No.: PCT/JP2021/038713

§ 371 Date: Apr. 24, 2023

(30) Foreign Application Priority Data
Nov. 4, 2020 (JP) 2020-184096

(51) Int. Cl. H04N 23/68; H04N 5/265

(52) U.S. Cl. CPC H04N 23/683; H04N 23/6811; H04N 5/265

(57) ABSTRACT

A signal processing device (100) according to an aspect of the present disclosure includes: an area determination section (106) that determines a predetermined area on a side opposite to a shake direction in an output image frame on a basis of the shake direction of an imaging element having an input image frame larger than the output image frame; and a storage section (for example, buffer memory 107) that stores an image of the predetermined area in the output image frame.

### FIELD

The present disclosure relates to a signal processing device, an imaging device, and a signal processing method.

### BACKGROUND

In electronic camera shake correction technology, for example, an imaging element having an input image frame (area of all pixels) wider than an output image frame (captured image frame) is used, image data of the input image frame is stored in a buffer memory, and the image data of the output image frame is recorded while the output image frame is shifted depending on the camera shake amount at the time of capturing an image.

In other electronic camera shake correction technology, there has been proposed a device that stores image data of an output image frame, that is, a captured image in a buffer memory, extracts a portion where a previous captured image and a subsequent captured image overlap from the subsequent captured image when the subsequent captured image is stored in the buffer memory, and overwrites the previous captured image with only an image of the extracted overlapping portion (see, for example, Patent Literature 1).

### CITATION LIST

### Patent Literature

Patent Literature 1: JP H08-46856 A

### SUMMARY

### Technical Problem

With the technology as described above, however, in a case where the shake amount due to camera shake or vibration is large, when the output image frame deviates from the input image frame, a part of the image data of the output image frame cannot be obtained, which causes a missing part in the captured image. In addition, since all the data of the captured image is stored in the buffer memory, a large storage capacity is required.

Therefore, the present disclosure provides a signal processing device, an imaging device, and a signal processing method capable of implementing suppression of a missing part in a captured image and reduction of the storage capacity.

### Solution to Problem

A signal processing device according to an aspect of the present disclosure includes: an area determination section that determines a predetermined area on a side opposite to a shake direction in an output image frame on a basis of the shake direction of an imaging element having an input image frame larger than the output image frame; and a storage section that stores an image of the predetermined area in the output image frame.

### BRIEF DESCRIPTION OF DRAWINGS

FIG. 1 is a block diagram illustrating a schematic configuration example of a signal processing device according to a first embodiment.

FIG. 2 is a flowchart illustrating a flow of image processing according to the first embodiment.

FIG. 3 is a first explanatory diagram for explaining area determination processing according to the first embodiment.

FIG. 4 is a second explanatory diagram for explaining the area determination processing according to the first embodiment.

FIG. 5 is a third explanatory diagram for explaining the area determination processing according to the first embodiment.

FIG. 6 is a fourth explanatory diagram for explaining the area determination processing according to the first embodiment.

FIG. 7 is an explanatory diagram for explaining image synthesis processing according to the first embodiment.

FIG. 8 is a block diagram illustrating a schematic configuration example of an image signal synthesizing section according to the first embodiment.

FIG. 9 is a first explanatory diagram for explaining a modification of the area determination processing according to the first embodiment.

FIG. 10 is a second explanatory diagram for explaining a modification of the area determination processing according to the first embodiment.

FIG. 11 is a third explanatory diagram for explaining a modification of the area determination processing according to the first embodiment.

FIG. 12 is a fourth explanatory diagram for explaining a modification of the area determination processing according to the first embodiment.

FIG. 13 is a block diagram illustrating a schematic configuration example of a signal processing device according to a second embodiment.

FIG. 14 is a diagram illustrating a schematic configuration example of an imaging device.

FIG. 15 is a block diagram depicting an example of schematic configuration of a vehicle control system.

FIG. 16 is a diagram of assistance in explaining an example of installation positions of an outside-vehicle information detecting section and an imaging section.

### DESCRIPTION OF EMBODIMENTS

Hereinafter, embodiments of the present disclosure will be described in detail on the basis of the drawings. Note that a signal processing device, an imaging device, a signal processing method, and the like according to the present disclosure are not limited by the embodiments. Note that in each of the following embodiments, the same parts are denoted by the same symbols, and redundant description will be omitted.

One or a plurality of embodiments (including examples and modifications) described below can be each implemented independently. Meanwhile, at least a part of the plurality of embodiments described below may be combined with and implemented together with at least a part of another embodiment as desired. The plurality of embodiments may include novel features different from each other. Therefore, the plurality of embodiments can contribute to solving different objects or problems and achieve different effects. Note that the effects of the embodiments are merely examples and are not limiting, and other effects may be achieved.

The present disclosure will be described in the following order of items.
1. First Embodiment
1-1. Schematic Configuration Example of Signal Processing Device
1-2. Image Processing
1-3. Area Determination Processing
1-4. Image Synthesis Processing
1-5. Schematic Configuration Example of Image Signal Synthesizing Section
1-6. Modification of Area Determination Processing
1-7. Action and Effects
2. Second Embodiment
3. Other Embodiments
4. Application Examples
5. Further Application Examples
6. Appendix

### 1. First Embodiment

<1-1. Schematic Configuration Example of Signal Processing Device>

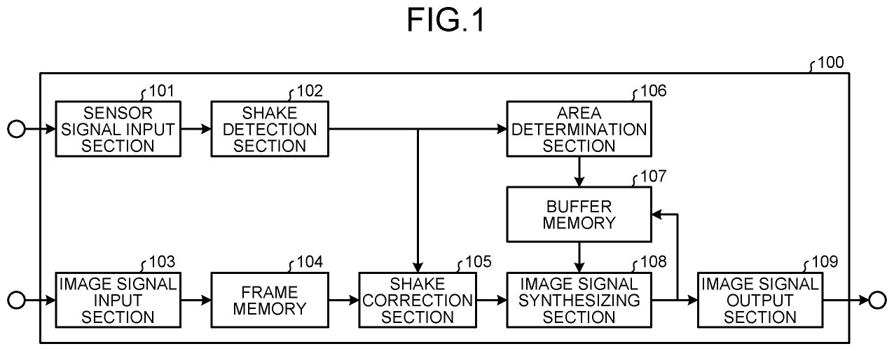

A schematic configuration example of a signal processing device 100 according to a first embodiment will be described by referring to FIG. 1. FIG. 1 is a block diagram illustrating a schematic configuration example of the signal processing device 100 according to the first embodiment.

As illustrated in FIG. 1, the signal processing device 100 includes a sensor signal input section 101, a shake detection section 102, an image signal input section 103, a frame memory 104, a shake correction section 105, an area determination section 106, a buffer memory 107, an image signal synthesizing section 108, and an image signal output section 109. The buffer memory 107 functions as a storage section.

The signal processing device 100 is built in, for example, an imaging device including an imaging element, various sensors, a monitor, and the like. As the imaging element, for example, a complementary metal oxide semiconductor (CMOS) image sensor, a charge coupled device (CCD) image sensor, or the like is used. Examples of the various sensors include an acceleration sensor and an angular velocity sensor.

The sensor signal input section 101 receives sensor signals (for example, acceleration and angular velocity) supplied from the various sensors of the imaging device, performs analog-to-digital (AD) conversion, and transmits the AD-converted data to the shake detection section 102.

The shake detection section 102 receives the data (for example, acceleration and angular velocity data) transmitted from the sensor signal input section 101, analyzes the posture state of the imaging device from the received data, and obtains shake information regarding the shake of the imaging device. Then, the shake detection section 102 transmits the obtained shake information to the shake correction section 105 and the area determination section 106.

For example, the shake detection section 102 receives data (for example, acceleration and angular velocity data) for each image captured by the imaging device, analyzes the posture state of the imaging device for each image captured by the imaging device, and obtains shake information regarding the shake of the imaging device from a change in the posture state of the imaging device based on previous and subsequent pieces of data.

Here, the shake information includes a shake direction and a shake amount (a movement direction and a movement amount) of the imaging device, that is, the imaging element. For example, the shake information may include a movement direction and a movement amount (movement vector) of an image (for example, a subsequent image) with respect to a reference image (for example, a previous image) on the basis of the shake direction and the shake amount of the imaging element. The shake information includes, for example, a movement direction and a movement amount for each image frame, each pixel block, or each pixel.

The image signal input section 103 receives an image signal (image data) supplied from the imaging element of the imaging device and transmits the image signal as an image frame to the frame memory 104.

The frame memory 104 receives and temporarily stores the image frame (image data) transmitted from the image signal input section 103.

The shake correction section 105 reads the image signal (image data) from the frame memory 104 and performs shake correction processing on the read image signal on the basis of the shake information transmitted from the shake detection section 102.

For example, on the basis of the shake direction and the shake amount included in the shake information, the shake correction section 105 corrects the image signal so as to cancel the shake for each image frame, each pixel block, or each pixel. As an example, the shake correction section 105 moves the output image frame by the shake amount (movement amount) in a direction opposite to the shake direction (movement direction) on the basis of the movement direction and the movement amount included in the shake information.

Note that, in a case where no image signal for canceling the shake is included in the image signal read from the frame memory 104, the shake correction section 105 transmits coordinates of a missing part (missing area) not including the image signal to the image signal synthesizing section 108 as missing information.

On the basis of the shake information transmitted from the shake detection section 102, the area determination section 106 determines an area of an image signal to be held from among the image signals to be output, that is, a recording area. The area determination processing will be described later in detail.

The buffer memory 107 holds an image signal (image signal of the recording area) corresponding to the recording area determined by the area determination section 106 from among the image signals to be output.

In a case where the missing information is not received from the shake correction section 105, the image signal synthesizing section 108 transmits the image signal having been subjected to the shake correction as it is to the image signal output section 109.

On the other hand, when receiving the missing information from the shake correction section 105, the image signal synthesizing section 108 acquires a missing image signal (image signal corresponding to the missing part) from the buffer memory 107 on the basis of the received missing information. Then, the image signal synthesizing section 108 combines the missing image signal acquired from the buffer memory 107 with the image signal having been subjected to the shake correction and transmits the image signal having been subjected to the shake correction and the synthesis to the image signal output section 109.

The image signal output section 109 outputs the image signal having been subjected to the shake correction or the image signal having been subjected to the shake correction and the synthesis to the monitor of the imaging device.

Here, each of the functional sections such as the sensor signal input section 101, the shake detection section 102, the image signal input section 103, the frame memory 104, the shake correction section 105, the area determination section 106, the buffer memory 107, the image signal synthesizing section 108, and the image signal output section 109 described above may be configured by both or either one of hardware and software, and the configuration thereof is not particularly limited.

For example, each of the above functional sections may be implemented by computer such as a central processing unit (CPU) or a micro control unit (MPU) executing a program prestored in a ROM using a RAM or the like as a work area. Furthermore, each of the functional sections may be implemented by, for example, an integrated circuit such as an application specific integrated circuit (ASIC) or a field-programmable gate array (FPGA). Furthermore, the frame memory 104 and the buffer memory 107 may be implemented by, for example, a non-volatile memory such as a flash memory or a hard disk drive.

<1-2. Image Processing>

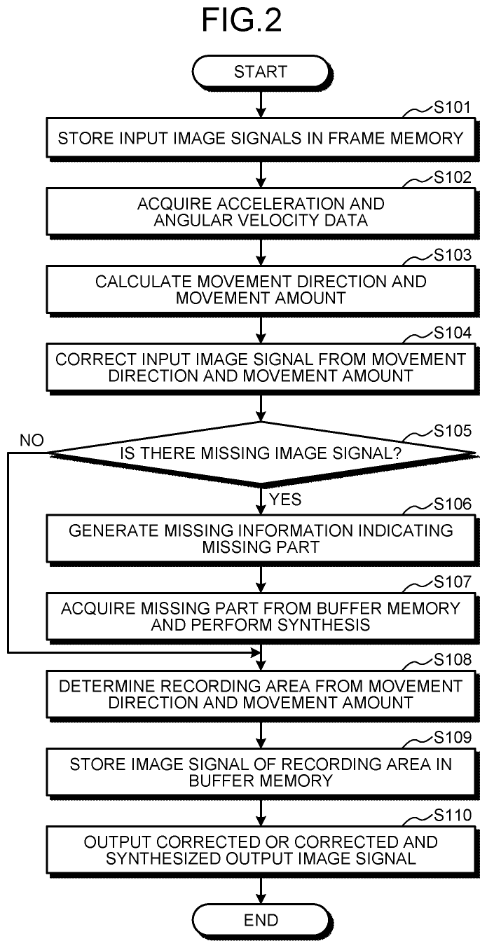

Image processing according to the first embodiment will be described with reference to FIG. 2. FIG. 2 is a flowchart illustrating a flow of image processing according to the first embodiment.

As illustrated in FIG. 2, in step S101, the image signal input section 103 acquires an image signal (input image signal) input to the signal processing device 100 and stores the image signal in the frame memory 104.

In step S102, the sensor signal input section 101 acquires acceleration and angular velocity data input to the signal processing device 100.

In step S103, the shake detection section 102 calculates a movement direction and a movement amount (for example, the movement direction and the movement amount of the image with respect to the reference image) of the imaging element as shake information.

In step S104, the shake correction section 105 performs shake correction processing on the input image signal of the frame memory 104 on the basis of the movement direction and the movement amount included in the shake information.

In step S105, the shake correction section 105 determines whether or not there is a missing part in the image signal after the shake correction processing.

In step S105, if it is determined that there is a missing part (Yes), the shake correction section 105 generates missing information indicating the missing part in step S106. For example, the missing information includes coordinate information indicating the missing part (missing area).

In step S107, the image signal synthesizing section 108 reads the missing part (image signal corresponding to the missing part) from the buffer memory 107 on the basis of the missing information and, by synthesizing the image signal after the shake correction processing, generates an output image signal.

On the other hand, in step S105, if it is determined that there is no missing part (No), the shake correction section 105 skips steps S106 and S107 and sets the image signal after the shake correction processing as the output image signal.

In step S108, the area determination section 106 determines the recording area for storing the output image signal in the buffer memory 107 on the basis of the movement direction and the movement amount included in the shake information.

In step S109, the area determination section 106 stores the image signal of the recording area in the output image signal in the buffer memory 107 on the basis of the recording area determined in step S108.

In step S110, the image signal output section 109 outputs the corrected output image signal or the corrected and synthesized output image signal.

Note that the execution order of the processing steps described above is an example, and each of the processing steps may be executed after data required for the step is collected.

<1-3. Area Determination Processing>

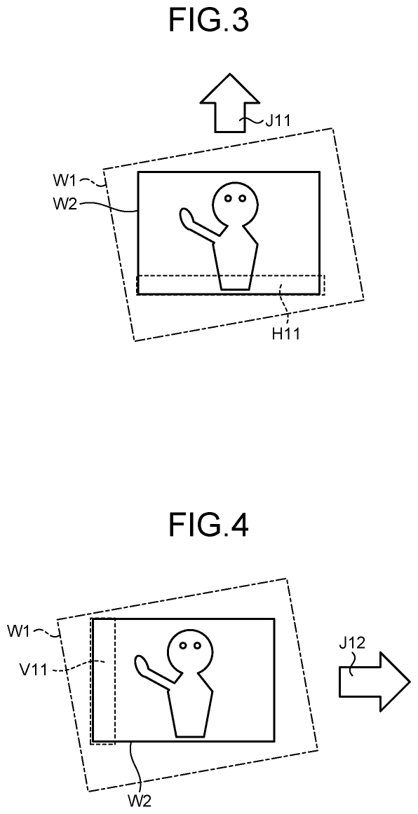

The area determination processing according to the first embodiment will be described with reference to FIGS. 3 to 6. FIGS. 3 to 6 are explanatory diagrams for explaining the area determination processing according to the first embodiment.

As illustrated in FIGS. 3 to 6, an imaging element having an input image frame W1 and an output image frame (captured image frame) W2 is used. The input image frame W1 is a frame indicating an area of an image that is input (input image), and the output image frame W2 is a frame indicating an area of an image that is output (output image). The input image frame W1 has a wider area than that of the output image frame W2. For example, the input image frame W1 corresponds to the area of all the pixels (imaging-capable pixel area) of the imaging element.

As illustrated in FIG. 3, the area determination section 106 sets, as a recording area H11, a predetermined area on the lower side (a lower area of the output image frame W2), in which there is a high possibility that an image signal to be output will be missing, depending on an upward movement direction and the movement amount based on shake information J11 indicated by an arrow. Note that the size of the predetermined area is set depending on the movement amount, and the predetermined area is set depending on the size corresponding to the movement amount.

In the example of FIG. 3, the recording area H11 has a rectangular shape, and the lower end of the recording area H11 overlaps with the lower end of the output image frame W2. The lateral width (length in the left-right direction) of the recording area H11 is the same as the lateral width of the output image frame W2, and the vertical height (length in the up-down direction) of the recording area H11 is narrower than the vertical height (for example, ½ of the vertical height) of the output image frame W2.

As illustrated in FIG. 4, the area determination section 106 sets, as a recording area V11, a predetermined area on the left side (a left-side area of the output image frame W2), in which there is a high possibility that an image signal to be output will be missing, depending on a rightward movement direction and the movement amount based on shake information J12 indicated by an arrow.

In the example of FIG. 4, the recording area V11 has a rectangular shape, and the left end of the recording area V11 overlaps with the left end of the output image frame W2. The vertical height of the recording area V11 is the same as the vertical height of the output image frame W2, and the lateral width of the recording area V11 is narrower than the lateral width (for example, ½ of the lateral width) of the output image frame W2.

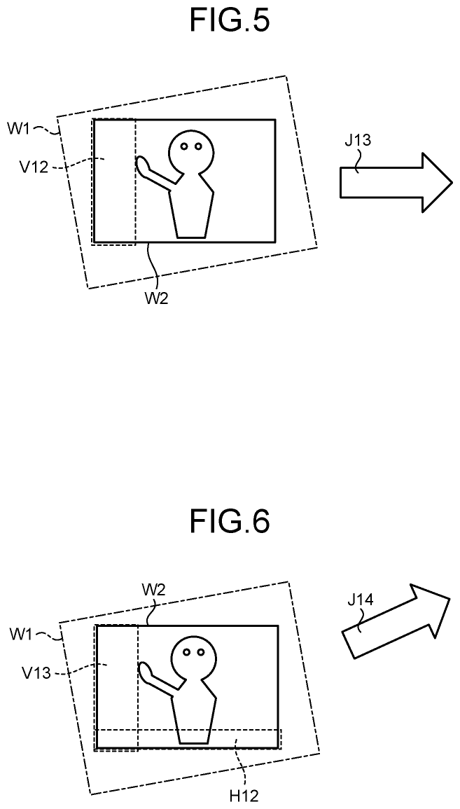

As illustrated in FIG. 5, the area determination section 106 increases the size of a left side area (a left-side area of the output image frame W2), in which there is a high possibility that an image signal to be output is will be missing, than the recording area V11 illustrated in FIG. 4 depending on the rightward movement direction and the movement amount based on shake information J13 indicated by an arrow and sets the left side area as a recording area V12. Note that the movement amount of the shake information J13 is larger than the movement amount of the shake information J12 illustrated in FIG. 4.

In the example of FIG. 5, the shape, the position, and the like of the recording area V12 are similar to those of the recording area V11 illustrated in FIG. 4, however, the lateral width of the recording area V12 is wider than the lateral width of the recording area V11 illustrated in FIG. 4.

As illustrated in FIG. 6, the area determination section 106 sets, as a recording area V13, a predetermined area on the left side (a left-side area of the output image frame W2) where there is a high possibility that an image signal to be output will be missing, and sets, as a recording area H12, a predetermined area on the lower side (a lower area of the output image frame W2) where there is a high possibility that an image signal to be output will be missing, depending on the movement direction and the movement amount to the upper right based on shake information J14 indicated by an arrow.

In the example of FIG. 6, the shape, the size, the position, and the like of the recording area V13 are similar to those of the recording area V12 illustrated in FIG. 5, and the shape, the size, the position, and the like of the recording area H12 are similar to those of the recording area H11 illustrated in FIG. 3.

Specifically, the area determination section 106 separates the movement direction and the movement amount to the upper right based on the shake information J14 indicated by the arrow into rightward movement direction and movement amount and upward movement direction and movement amount and sets the predetermined area on the left side as the recording area V13 depending on the rightward movement direction and movement amount and the predetermined area on the lower side as the recording area H12 depending on the upward movement direction and movement amount.

Incidentally, the recording areas V11 to V13 and H11 to H12 are predetermined areas on the opposite side to the movement direction in the output image frame W2, and are, for example, areas on the side where the interval with the input image frame W1 becomes narrower in the output image frame W2. In the example of FIG. 3, the lower side of the output image frame W2 is the portion approaching the input image frame W1. In the examples of FIGS. 4 and 5, the left side of the output image frame W2 is the portion approaching the input image frame W1, and in the example of FIG. 6, the left side and the lower side of the output image frame W2 are the portions approaching the input image frame W1. The areas including these portions having a high possibility of missing are set as the recording areas V11 to V13 and H11 to H12 and preferentially stored in the buffer memory 107.

As illustrated in FIGS. 3 to 6, the area determination section 106 sets predetermined areas on the opposite side of the movement direction in the output image frame W2 as the recording areas V11 to V13 and H11 to H12 depending on the movement direction based on the shake information J11 to J14. Furthermore, the area determination section 106 changes the sizes of the recording areas V11 to V13 and H11 to H12 of the output image frame W2 depending on the movement amounts based on the shake information J11 to J14.

For example, the area determination section 106 stores a relational expression representing the relationship (for example, a proportional relationship) between the movement amount and the sizes of the recording areas V11 to V13 and H11 to H12 and, using the relational expression, determines the sizes (for example, vertical heights, lateral widths, and others) of the recording areas V11 to V13 and H11 to H12 of the output image frame W2 depending on the movement amounts based on the shake information J11 to J14. Note that, in a case where the movement amount is zero, the size of the recording area is also zero, and no recording area is set.

<1-4. Image Synthesis Processing>

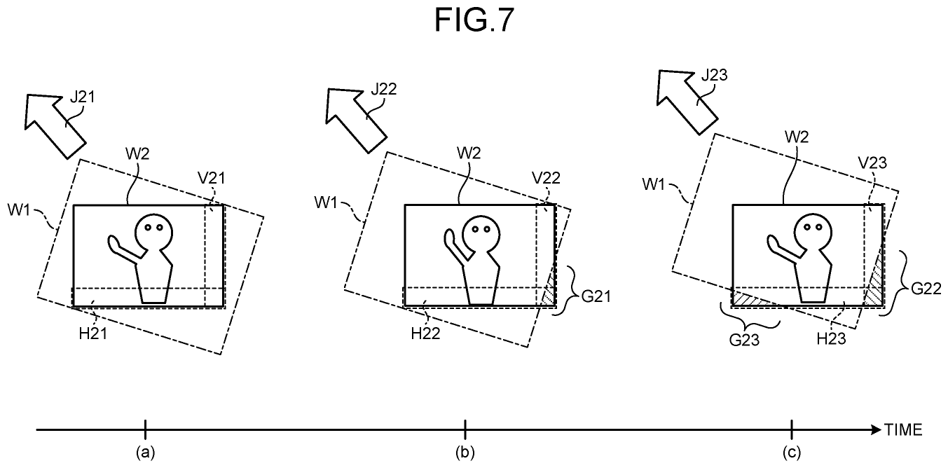

Image synthesis processing according to the first embodiment will be described with reference to FIG. 7. FIG. 7 is an explanatory diagram for explaining image synthesis processing according to the first embodiment. Note that (a), (b), and (c) in FIG. 7 indicate the chronological order.

As illustrated in FIG. 7, in (a), the area determination section 106 determines a recording area H21 and a recording area V21 from shake information J21 and stores image signals (image data) of the determined recording areas H21 and V21 in the buffer memory 107.

In (b), similarly to the processing in (a), the area determination section 106 determines a recording area H22 and a recording area V22 from shake information J22 and stores image signals of the determined recording areas H22 and V22 in the buffer memory 107. However, in a case where the output image frame W2 deviates from the input image frame W1 (the input image frame W1 deviates from the output image frame W2), the image signal synthesizing section 108 acquires an image signal corresponding to the missing part of the output image from the buffer memory 107 and combines the image signal with an image signal from the shake correction section 105.

Specifically, the image signal synthesizing section 108 acquires an image signal corresponding to a synthesis area G21, which is a missing part (missing area), from the recording area V21 and the recording area H21 stored in the above (a), performs low-pass filter processing (low-pass filter processing) on a boundary portion (image signal of a boundary area) between the acquired image signal and an image signal of the output image frame W2, and combines the acquired image signal and the image signal of the output image frame W2. In addition, the image signal synthesizing section 108 updates image signals of the buffer memory 107 with the image signals of the recording area V22 and the recording area H22 including the synthesis area G21.

In (c), similarly to the processing in (b), the area determination section 106 determines a recording area H23 and a recording area V23 from shake information J23 and stores image signals of the determined recording areas H23 and V23 in the buffer memory 107. However, in a case where the output image frame W2 deviates from the input image frame W1 (the input image frame W1 deviates from the output image frame W2), similarly to the processing in (b), the image signal synthesizing section 108 acquires an image signal corresponding to the missing part of the output image from the buffer memory 107 and combines the image signal with an image signal from the shake correction section 105.

Specifically, the image signal synthesizing section 108 acquires an image signal corresponding to a synthesis area G22, which is a missing part, from the recording area V22 and the recording area H22 stored in the above (b), performs low-pass filter processing on a boundary portion between the acquired image signal and an image signal of the output image frame W2, and combines the acquired image signal and the image signal of the output image frame W2. Furthermore, the image signal synthesizing section 108 acquires an image signal corresponding to a synthesis area G23, which is a missing part, from the recording area H22 stored in the above (b), performs low-pass filter processing on a boundary portion between the acquired image signal and an image signal of the output image frame W2, and combines the acquired image signal with the image signal of the output image frame W2. In addition, the image signal synthesizing section 108 updates image signals of the buffer memory 107 with the image signals of the recording area V23 and the recording area H23 including the synthesis area G22 and the synthesis area G23.

According to such image synthesis processing, in a case where the output image frame W2 deviates from the input image frame W1 (the input image frame W1 deviates from the output image frame W2), the image signal synthesizing section 108 acquires an image signal corresponding to the missing part from the image signals of the recording areas V21 to V23 and H21 to H23 stored in the buffer memory 107 and combines the acquired image signal with the image signal from the shake correction section 105. As a result, it is possible to compensate for the missing part of the output image, and thus it is possible to reliably suppress a loss in the output image due to shake such as camera shake or vibration.

In addition, the image signal synthesizing section 108 superimposes the image signal corresponding to the missing part on an image signal stored in the buffer memory 107 and updates the image signal stored in the buffer memory 107. In other words, the image signal synthesizing section 108 updates an area overlapping with a subsequent image signal in the image signal stored in the buffer memory 107 with the subsequent image signal. As a result, the image signal stored in the buffer memory 107 is updated as needed, and thus it is possible to reliably compensate for the missing part of the output image.

In addition, in a case where the image signal stored in the buffer memory 107 is combined with the image signal from the shake correction section 105 or in a case where the image signal stored in the buffer memory 107 is updated, the image signal synthesizing section 108 performs filter processing (for example, low-pass filter processing) on the image signal of the boundary area. As a result, it is possible to obtain an output image in which noise is suppressed in the boundary area.

<1-5. Schematic Configuration Example of Image Signal Synthesizing Section>

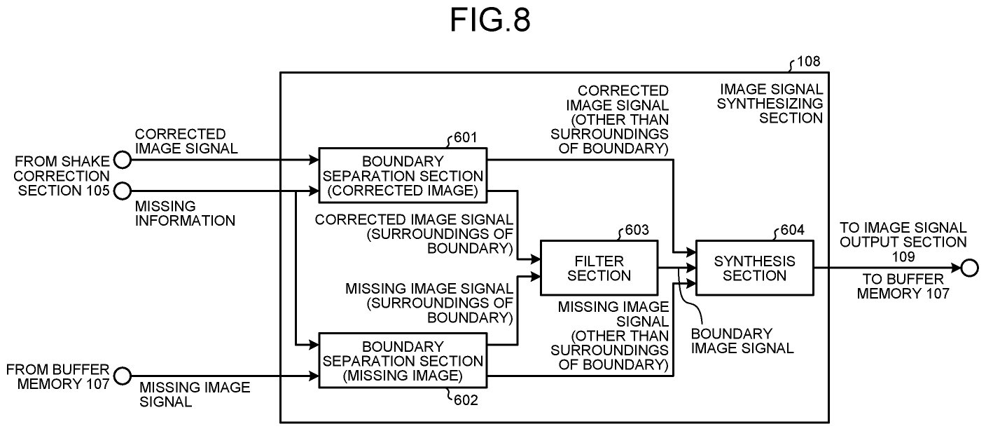

A schematic configuration example of the image signal synthesizing section 108 according to the first embodiment will be described with reference to FIG. 8. FIG. 8 is a block diagram illustrating a schematic configuration example of the image signal synthesizing section 108 according to the first embodiment.

As illustrated in FIG. 8, the image signal synthesizing section 108 includes a boundary separation section (corrected image) 601 for a corrected image, a boundary separation section (missing image) 602 for a missing image, a filter section 603, and a synthesis section 604.

Based on the missing information from the shake correction section 105, the boundary separation section 601 separates a corrected image signal from the shake correction section 105 into a corrected image signal around the boundary and a corrected image signal other than around the boundary. The boundary is a boundary between the corrected image and the missing image.

The boundary separation section 602 acquires a missing image signal (missing image data) from the buffer memory 107 on the basis of the missing information from the shake correction section 105 and separates the missing image signal into a missing image signal around the boundary and a missing image signal other than around the boundary.

The filter section 603 receives the corrected image signal around the boundary from the boundary separation section 601 and the missing image signal around the boundary from the boundary separation section 602 as input, performs filter processing (filtering) such as low-pass filtering, and generates a boundary image signal (image signal around the boundary).

The synthesis section 604 combines the corrected image signal other than around the boundary from the boundary separation section 601, the missing image signal other than around the boundary from the boundary separation section 602, and the boundary image signal from the filter section 603 and transmits the synthesized signal to the image signal output section 109 and the buffer memory 107 as an output image.

<1-6. Modification of Area Determination Processing>

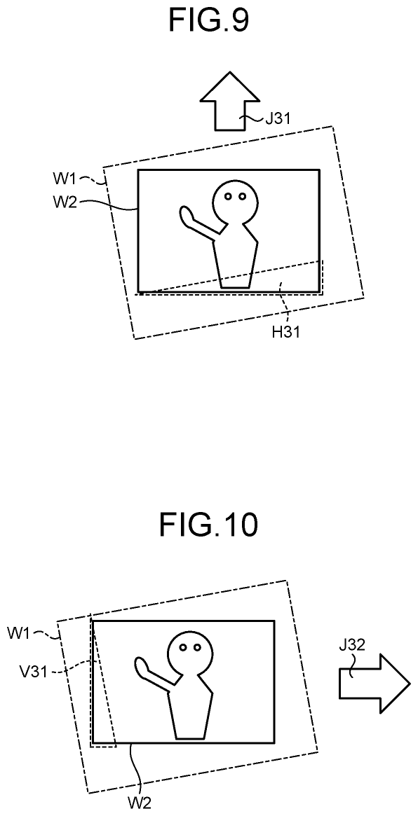

A modification (another embodiment) of the area determination processing according to the first embodiment will be described with reference to FIGS. 9 to 12. FIGS. 9 to 12 are explanatory diagrams for explaining the modification of the area determination processing according to the first embodiment.

As illustrated in FIG. 9, the area determination section 106 sets, as a recording area H31, a predetermined area that is a lower area (a lower area of the output image frame W2) in which an image signal to be output is likely to be lost and having an upper side parallel to the inclination of the input image frame W1 depending on an upward movement direction and movement amount based on shake information J31 indicated by an arrow.

In the example of FIG. 9, the shape of the recording area H31 is a right triangle, and the lower end of the recording area H31 overlaps with the lower end of the output image frame W2. The lateral width of the lower end of the recording area H31 is the same as the lateral width of the output image frame W2, and the vertical height of the right end of the recording area H31 is narrower than the vertical height (for example, ½ of the vertical height) of the output image frame W2.

As illustrated in FIG. 10, the area determination section 106 sets, as a recording area V31, a predetermined area that is a left-side area (a left-side area of the output image frame W2) in which an image signal to be output is likely to be lost and having a right side parallel to the inclination of the input image frame W1 depending on a rightward movement direction and movement amount based on shake information J32 indicated by an arrow.

In the example of FIG. 10, the recording area V31 has a right triangle shape, and the left end of the recording area V31 overlaps with the left end of the output image frame W2. The vertical height of the left end of the recording area V31 is the same as the vertical height of the output image frame W2, and the lateral width of the lower end of the recording area V31 is narrower than the lateral width (for example, ½ of the lateral width) of the output image frame W2.

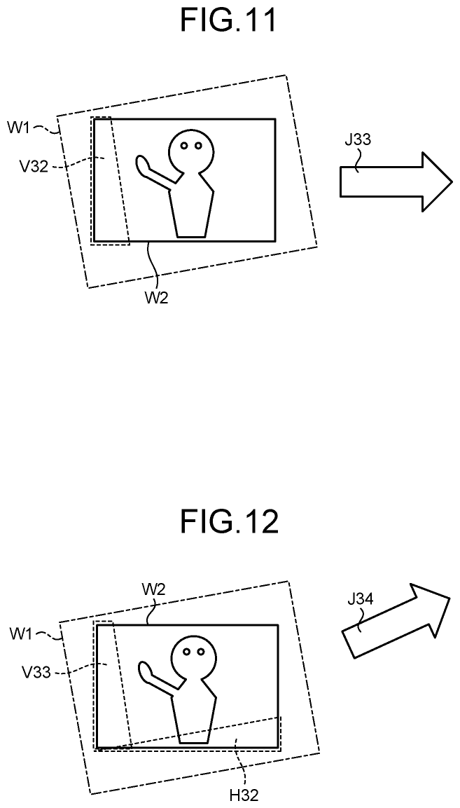

As illustrated in FIG. 11, the area determination section 106 makes a left-side area (a left-side area of the output image frame W2), in which an image signal to be output is likely to be lost and having a right side parallel to the inclination of the input image frame W1, larger than the recording area V31 illustrated in FIG. 10 and sets the left-side area as a recording area V32 depending on a rightward movement direction and movement amount based on shake information J33 indicated by an arrow. Note that the movement amount of the shake information J33 is larger than the movement amount of the shake information J32 illustrated in FIG. 10.

In the example of FIG. 11, the position and the like of the recording area V32 are similar to those of the recording area V31 illustrated in FIG. 10, however, the shape of the recording area V32 is trapezoidal, and the lateral widths of the upper end, the lower end, and the like of the recording area V32 are wider than the lateral widths of the upper end, the lower end, and the like of the recording area V31 illustrated in FIG. 10.

As illustrated in FIG. 12, depending on the movement direction and the movement amount to the upper right based on shake information J34 indicated by an arrow, the area determination section 106 sets a predetermined area that is a left-side area (left-side area of the output image frame W2) in which the image signal to be output is likely to be lost and having a right side parallel to the inclination of the input image frame W1 as a recording area V33 and sets a lower area (lower area of the output image frame W2) in which the image signal to be output is likely to be lost and having an upper side parallel to the inclination of the input image frame W1 as a recording area H32.

In the example of FIG. 12, the shape, the size, the position, and the like of the recording area V33 are similar to those of the recording area V32 illustrated in FIG. 11, and the shape, the size, the position, and the like of the recording area H32 are similar to those of the recording area H31 illustrated in FIG. 9.

Incidentally, the recording areas V31 to V33 and H31 to H32 are predetermined areas on the opposite side to the movement direction in the output image frame W2, and are, for example, areas on the side where the interval with the input image frame W1 becomes narrower in the output image frame W2. In the example of FIG. 9, the lower side of the output image frame W2 is the portion approaching the input image frame W1. In the examples of FIGS. 10 and 11, the left side of the output image frame W2 is the portion approaching the input image frame W1, and in the example of FIG. 12, the left side and the lower side of the output image frame W2 are the portions approaching the input image frame W1. Areas including these portions having a high possibility of missing are set as recording areas V31 to V33 and H31 to H32 and preferentially stored in the buffer memory 107.

As illustrated in FIGS. 9 to 12, the area determination section 106 sets predetermined areas on the opposite side of the movement direction in the output image frame W2 as the recording areas V31 to V33 and H31 to H32 depending on the movement direction based on the shake information J31 to J34. Furthermore, the area determination section 106 changes the sizes of the recording areas V31 to V33 and H31 to H32 of the output image frame W2 depending on the movement amounts based on the shake information J31 to J34.

Furthermore, the area determination section 106 sets areas inside the output image frame W2 each having one side parallel to the inclination of the input image frame W1 as the recording areas V31 to V33 and H31 to H32. In this case, since the areas of the recording areas V31 to V33 and H31 to H32 are smaller than those of the recording areas V11 to V13 and H11 to H12 illustrated in FIGS. 3 to 6, the amount used in the buffer memory 107 can be suppressed.

<1-7. Action and Effects>

As described above, according to the first embodiment, even in a case where the shake is large and the output image frame W2 is out of the input image frame W1, a missing part in the output image can be suppressed by performing correction by combining images having been stored in advance. In addition, the memory use amount can be reduced by determining a recording area of the output image frame W2 depending on the shake direction or the shake amount and storing the image of the determined recording area. Furthermore, by updating the image of the recording area for each image frame and performing filter processing, for example, low-pass filter processing at the boundary between the missing part and the image, an output image with suppressed noise can be obtained.

The area determination section 106 determines predetermined areas (for example, the recording areas V11 to V13, V21 to V23, V31 to V33, H11 to H12, H21 to H23, and H31 to H32) on the opposite side of the shake direction of the output image frame W2 on the basis of the shake direction (for example, the shake direction of the image with respect to a reference image) of the imaging element having the input image frame W1 wider than the output image frame W2. The buffer memory 107 functioning as the storage section stores images of the predetermined areas in the output image frame W2. As a result, even when a missing part occurs on the opposite side of the shake direction in the output image of the output image frame W2, it is possible to compensate for the missing part of the output image using the stored image of the predetermined area, and thus it is possible to suppress a missing part in the image due to shake such as camera shake and vibration. Furthermore, since the size of the image to be stored can be suppressed and the use amount of the buffer memory 107 can be suppressed, the storage capacity can be reduced.

Furthermore, the area determination section 106 changes the size of the predetermined area depending on the shake amount of the imaging element. As a result, since the image of the predetermined area having a size corresponding to the shake amount is stored, it is possible to reliably compensate for the missing part of the output image using the stored image of the predetermined area, and thus it is possible to reliably suppress a loss in the output image due to shake such as camera shake or vibration.

In addition, the shake correction section 105 moves the output image frame W2 by the shake amount of the imaging element in a direction opposite to the shake direction of the imaging element. As a result, the output image frame W2 moves depending on the shake direction and the shake amount of the imaging element, which makes it possible to suppress a missing part of the output image, and thus it is possible to reliably suppress a missing part of the output image due to shake such as camera shake and vibration.

In addition, the image signal synthesizing section 108 combines a stored image of a predetermined area in the output image frame W2 with a newly obtained image of the output image frame W2. For example, the image signal synthesizing section 108 acquires an image corresponding to a missing part of the newly obtained image of the output image frame W2 from the stored image of the predetermined area in the output image frame W2 and combines the image with the newly obtained image of the output image frame W2. As a result, it is possible to reliably compensate for the missing part of the output image using the stored image of the predetermined area, and thus it is possible to reliably suppress a loss in the output image due to shake such as camera shake or vibration.

In addition, the image signal synthesizing section 108 superimposes an image corresponding to the missing part on the stored image of the predetermined area and updates the stored image of the predetermined area. As a result, it is possible to reliably compensate for the missing part of the output image using the stored image of the predetermined area, and thus it is possible to reliably suppress a loss in the output image due to shake such as camera shake or vibration.

In addition, the image signal synthesizing section 108 performs filter processing on a boundary area between the newly obtained image of the output image frame W2 and the image corresponding to the missing part. For example, by performing low-pass filter processing as the filter processing, it is possible to obtain an output image in which noise is suppressed in the boundary area.

Note that the shape of the predetermined area may vary depending on the inclination of the input image frame W1 with respect to the output image frame W2. For example, one side inside of the predetermined area (inside the output image frame W2) may be parallel to the inclination of the input image frame W1. In this case, the size of the predetermined area can be suppressed, the size of the image to be stored can be suppressed, and the use amount of the buffer memory 107 can be further suppressed, so that the storage capacity can be further reduced.

### 2. Second Embodiment

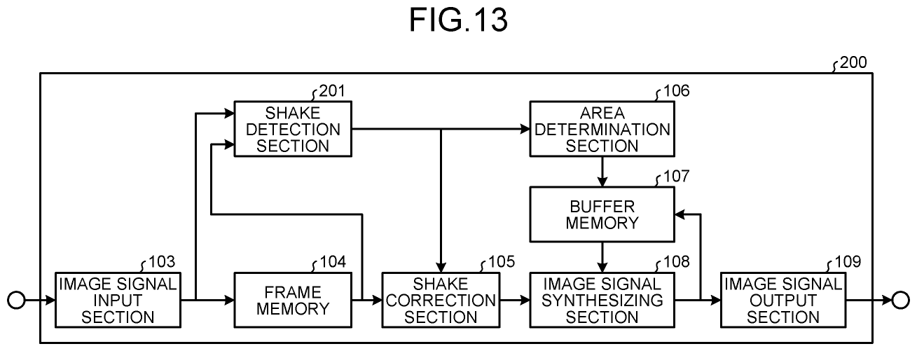

A schematic configuration example of a signal processing device 200 according to a second embodiment will be described with reference to FIG. 13. FIG. 13 is a block diagram illustrating a schematic configuration example of the signal processing device 200 according to the second embodiment. Hereinafter, differences from the first embodiment will be mainly described, and other descriptions will be omitted.

As illustrated in FIG. 13, a shake detection section 201 according to the second embodiment calculates a movement direction and a movement amount of an imaging device, that is, a movement vector indicating a movement direction and a movement amount of the imaging element (for example, the movement direction and the movement amount of the image with respect to a reference image) from a difference between an image signal of a previous frame held in the frame memory 104 and an image signal of the current frame input from the image signal input section 103. Then, the shake detection section 201 uses the calculated movement vector as shake information.

As described above, according to the second embodiment, the shake detection section 201 can form shake information from image signals of preceding and subsequent frames, and sensor signals (for example, acceleration and angular velocity) from the imaging device are unnecessary. As a result, the sensor signal input section 101 according to the first embodiment can be omitted, and the device configuration can be simplified. Note that also in the second embodiment, the same effect as that of the first embodiment can be obtained.

### 3. Other Embodiments

The processing according to the above embodiments may be performed in various different modes (modifications) other than the above embodiments. For example, the system configuration is not limited to the above-described example and may be various modes. For example, among the processing described in the above embodiments, the whole or a part of the processing described as that performed automatically can be performed manually, or the whole or a part of the processing described as that performed manually can be performed automatically by a known method. In addition, a processing procedure, a specific name, and information including various types of data or parameters illustrated in the above or in the drawings can be modified as desired unless otherwise specified. For example, various types of information illustrated in the drawings are not limited to the information that has been illustrated.

In addition, each component of each device illustrated in the drawings is conceptual in terms of function and is not necessarily physically configured as illustrated in the drawings. That is, the specific form of distribution or integration of each device is not limited to those illustrated in the drawings, and the whole or a part thereof can be functionally or physically distributed or integrated in any unit depending on various loads, usage status, and others.

In each of the above-described embodiments, examples in which the signal processing devices 100 and 200 are incorporated in the imaging devices have been described, however, it is not limited thereto, and the signal processing devices 100 and 200 may be provided outside the imaging devices. In this case, in order to implement transmission and reception of various types of data between the signal processing devices 100 and 200 and the imaging device, for example, a configuration that enables wireless or wired communication between the signal processing devices 100 and 200 and the imaging device may be used.

### 4. Application Examples

The signal processing device 100 described above can be applied to various electronic devices such as imaging devices such as a digital still camera or a digital video camera and other devices having an imaging function. Examples of other devices (imaging devices) having an imaging function include various devices such as a smartphone, a tablet terminal, a mobile phone, a personal digital assistant (PDA), a laptop personal computer (PC), and a desktop PC.

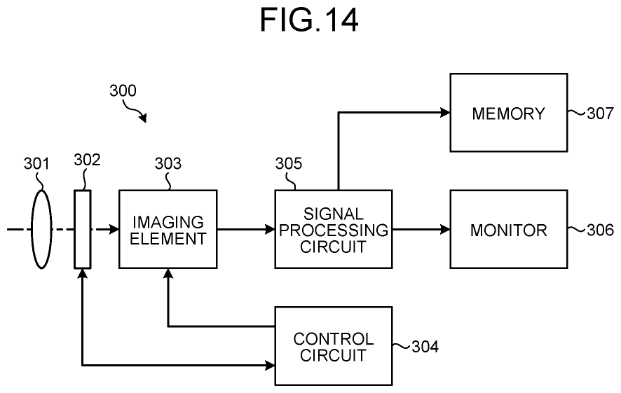

An imaging device 300 will be described with reference to FIG. 14. FIG. 14 is a block diagram illustrating a configuration example of the imaging device 300 as an electronic device to which the present technology is applied.

As illustrated in FIG. 14, the imaging device 300 includes an optical system 301, a shutter device 302, an imaging element 303, a control circuit (drive circuit) 304, a signal processing circuit 305, a monitor 306, and a memory 307. The imaging device 300 is capable of capturing a still image and a moving image.

Incidentally, the signal processing circuit 305 is an example of the signal processing devices 100 and 200 described above. Note that, in a case where the signal processing device 100 is used as the signal processing circuit 305, various sensors are included in the imaging device 300. Examples of the various sensors include an acceleration sensor and an angular velocity sensor.

The optical system 301 includes one or a plurality of lenses. The optical system 301 guides light (incident light) from a subject to the imaging element 303 and forms an image on a light receiving surface of the imaging element 303.

The shutter device 302 is disposed between the optical system 301 and the imaging element 303. The shutter device 302 controls a light irradiation period and a light shielding period with respect to the imaging element 303 in accordance with the control by the control circuit 304.

The imaging element 303 accumulates signal charge for a certain period of time in response to light formed on the light receiving surface via the optical system 301 and the shutter device 302. The signal charge accumulated in the imaging element 303 is transferred in accordance with a drive signal (timing signal) supplied from the control circuit 304. As the imaging element 303, for example, a CMOS image sensor, a CCD image sensor, or the like is used.

The control circuit 304 outputs a drive signal for controlling the transfer operation of the imaging element 303 and the shutter operation of the shutter device 302 to drive the imaging element 303 and the shutter device 302.

The signal processing circuit 305 performs various types of signal processing on the signal charge output from the imaging element 303. An image (image data) obtained by performing the signal processing by the signal processing circuit 305 is supplied to and displayed on the monitor 306 and is also supplied to and stored (recorded) in the memory 307.

Also in the imaging device 300 configured in this manner, by applying the above-described signal processing devices 100 and 200 as the signal processing circuit 305, it is possible to implement suppression of a missing part of a captured image due to shake such as camera shake and vibration and reduction of the storage capacity.

### 5. Further Application Examples

The technology according to the present disclosure can be applied to various products. For example, the technology according to the present disclosure may be implemented as a device to be mounted on a mobile body of any type such as automobiles, electric vehicles, hybrid electric vehicles, motorcycles, bicycles, personal mobilities, airplanes, drones, ships, robots, construction machines, or agricultural machines (tractors).

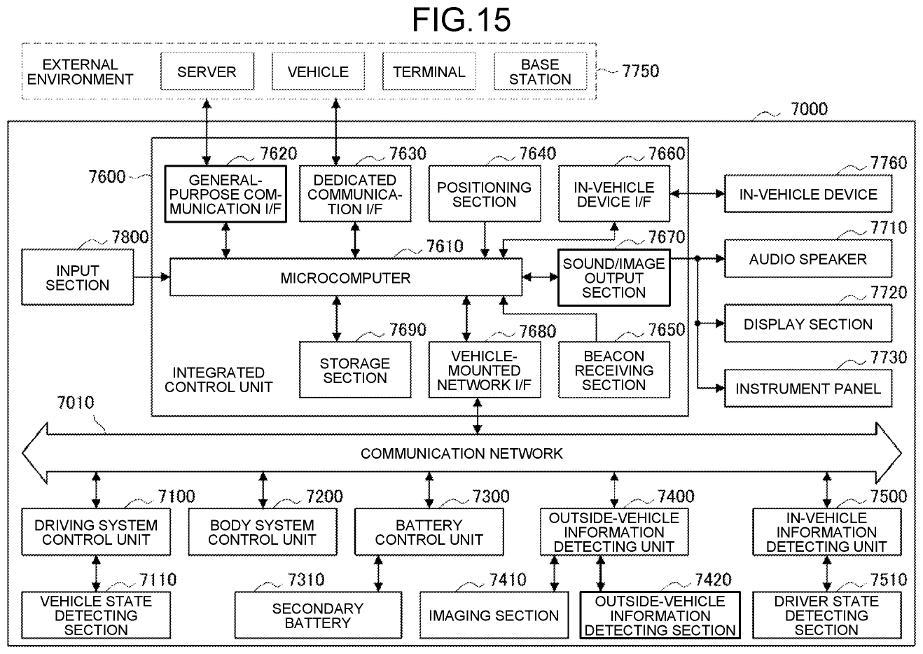

FIG. 15 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 15, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 15 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

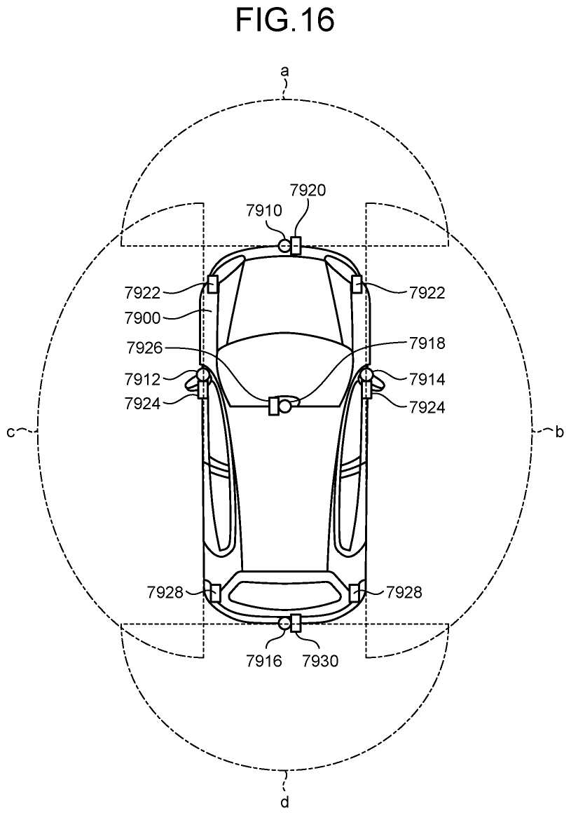

FIG. 16 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 16 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7914 and 7912 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 15, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 15, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 15 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for implementing each of the functions of the signal processing devices 100 and 200 according to the embodiments described with reference to FIG. 1 and FIG. 13 can be implemented in any one of the control units or the like. It is also possible to provide a computer-readable recording medium storing such a computer program. The recording medium is, for example, a magnetic disk, an optical disk, a magneto-optical disk, a flash memory, or the like. Alternatively, the computer program described above may be distributed via, for example, a network without using a recording medium.

In the vehicle control system 7000 described above, the signal processing devices 100 and 200 according to the embodiments described with reference to FIGS. 1 and 13 can be applied to the integrated control unit 7600 of the further application example illustrated in FIG. 15. For example, each of the sections of the signal processing devices 100 and 200 corresponds to the microcomputer 7610, the storage section 7690, or others of the integrated control unit 7600. For example, with the integrated control unit 7600 appropriately executing various types of processing such as image processing, area determination processing, image synthesis processing, and shake correction processing, it becomes possible to implement suppression of a missing part of the captured image due to shake such as camera shake and vibration and reduction of the storage capacity.

In addition, at least some components of the signal processing devices 100 and 200 according to the embodiments described with reference to FIGS. 1 and 13 may be implemented in a module (for example, an integrated circuit module including one die) for the integrated control unit 7600 as the further application example illustrated in FIG. 15. Alternatively, the signal processing devices 100 and 200 according to the embodiments described with reference to FIGS. 1 and 13 may be implemented by a plurality of control units of the vehicle control system 7000 illustrated in FIG. 15.

### 6. Appendix

Note that the present technology can also have the following configurations.

(1)

A signal processing device comprising:
an area determination section that determines a predetermined area on a side opposite to a shake direction in an output image frame on a basis of the shake direction of an imaging element having an input image frame larger than the output image frame; and
a storage section that stores an image of the predetermined area in the output image frame.

(2)

The signal processing device according to (1),
wherein the area determination section
changes a size of the predetermined area depending on a shake amount of the imaging element.

(3)

The signal processing device according to (1) or (2), further comprising:
a shake correction section that moves the output image frame by a shake amount of the imaging element in a direction opposite to the shake direction.

(4)

The signal processing device according to (3),
wherein the predetermined area is an area on a side in the output image frame where an interval from the input image frame becomes narrower.

(5)

The signal processing device according to any one of (1) to (4), further comprising:
a shake detection section that detects the shake direction.

(6)

The signal processing device according to (5),
wherein the shake detection section
detects a shake amount of the image.

(7)

The signal processing device according to any one of (1) to (6), further comprising:
an image signal synthesizing section that combines the image of the predetermined area that has been stored and a newly obtained image of the output image frame.

(8)

The signal processing device according to (7),
wherein the image signal synthesizing section
acquires an image corresponding to a missing part of the image in the output image frame, which has been newly obtained, from the image of the predetermined area that is stored and combines the image with the image in the output image frame which has been newly obtained.

(9)

The signal processing device according to (8),
wherein the image signal synthesizing section
superimposes the image corresponding to the missing part on the image of the predetermined area that is stored and updates the image of the predetermined area that is stored.

(10)

The signal processing device according to (8) or (9),
wherein the image signal synthesizing section
performs filter processing on a boundary area between the image in the output image frame that has been newly obtained and the image corresponding to the missing part.

(11)

The signal processing device according to any one of (1) to (10),
wherein a shape of the predetermined area varies depending on an inclination of the input image frame with respect to the output image frame.

(12)

The signal processing device according to (11),
wherein a side inside the predetermined area is parallel to an inclination of the input image frame.

(13)

An imaging device comprising:
an imaging element having an input image frame wider than an output image frame; and
a signal processing device,
wherein the signal processing device includes:
an area determination section that determines a predetermined area on a side opposite to a shake direction in the output image frame on a basis of the shake direction of the imaging element; and
a storage section that stores an image of the predetermined area in the output image frame.

(14)

A signal processing method comprising:
determining a predetermined area on a side opposite to a shake direction in an output image frame on a basis of the shake direction of an imaging element having an input image frame larger than the output image frame; and
storing an image of the predetermined area in the output image frame.

(15)

An imaging device including the signal processing device according to any one of (1) to (12).

(16)

A signal processing method using the signal processing device according to any one of (1) to (12).

### REFERENCE SIGNS LIST

100 SIGNAL PROCESSING DEVICE
101 SENSOR SIGNAL INPUT SECTION
102 SHAKE DETECTION SECTION
103 IMAGE SIGNAL INPUT SECTION
104 FRAME MEMORY
105 SHAKE CORRECTION SECTION
106 AREA DETERMINATION SECTION
107 BUFFER MEMORY
108 IMAGE SIGNAL SYNTHESIZING SECTION
109 IMAGE SIGNAL OUTPUT SECTION
200 SIGNAL PROCESSING DEVICE
201 SHAKE DETECTION SECTION
300 IMAGING DEVICE
303 IMAGING ELEMENT
305 SIGNAL PROCESSING CIRCUIT
601 BOUNDARY SEPARATION SECTION (CORRECTED IMAGE)
602 BOUNDARY SEPARATION SECTION (MISSING IMAGE)
603 FILTER SECTION
604 SYNTHESIS SECTION
H11 to H12 RECORDING AREA
H21 to H23 RECORDING AREA
H31 to H32 RECORDING AREA
J11 to J14 SHAKE INFORMATION
J21 to J23 SHAKE INFORMATION
J31 to J34 SHAKE INFORMATION
V11 to V13 RECORDING AREA
V21 to V23 RECORDING AREA
V31 to V33 RECORDING AREA
W1 INPUT IMAGE FRAME
W2 OUTPUT IMAGE FRAME

1. A signal processing device comprising:
an area determination section that determines a predetermined area on a side opposite to a shake direction in an output image frame on a basis of the shake direction of an imaging element having an input image frame larger than the output image frame; and
a storage section that stores an image of the predetermined area in the output image frame.

2. The signal processing device according to claim 1,
wherein the area determination section
changes a size of the predetermined area depending on a shake amount of the imaging element.

3. The signal processing device according to claim 1, further comprising:
a shake correction section that moves the output image frame by a shake amount of the imaging element in a direction opposite to the shake direction.

4. The signal processing device according to claim 3,
wherein the predetermined area is an area on a side in the output image frame where an interval from the input image frame becomes narrower.

5. The signal processing device according to claim 1, further comprising:
a shake detection section that detects the shake direction.

6. The signal processing device according to claim 5,
wherein the shake detection section
detects a shake amount of the image.

7. The signal processing device according to claim 1, further comprising:
an image signal synthesizing section that combines the image of the predetermined area that has been stored and a newly obtained image of the output image frame.

8. The signal processing device according to claim 7,
wherein the image signal synthesizing section
acquires an image corresponding to a missing part of the image in the output image frame, which has been newly obtained, from the image of the predetermined area that is stored and combines the image with the image in the output image frame which has been newly obtained.

9. The signal processing device according to claim 8,
wherein the image signal synthesizing section
superimposes the image corresponding to the missing part on the image of the predetermined area that is stored and updates the image of the predetermined area that is stored.

10. The signal processing device according to claim 8,
wherein the image signal synthesizing section
performs filter processing on a boundary area between the image in the output image frame that has been newly obtained and the image corresponding to the missing part.

11. The signal processing device according to claim 1,
wherein a shape of the predetermined area varies depending on an inclination of the input image frame with respect to the output image frame.

12. The signal processing device according to claim 11,
wherein a side inside the predetermined area is parallel to an inclination of the input image frame.

13. An imaging device comprising:
an imaging element having an input image frame wider than an output image frame; and
a signal processing device,
wherein the signal processing device includes:
an area determination section that determines a predetermined area on a side opposite to a shake direction in the output image frame on a basis of the shake direction of the imaging element; and
a storage section that stores an image of the predetermined area in the output image frame.

14. A signal processing method comprising:
determining a predetermined area on a side opposite to a shake direction in an output image frame on a basis of the shake direction of an imaging element having an input image frame larger than the output image frame; and
storing an image of the predetermined area in the output image frame.
